(19) United States
(12) Patent Application Publication
(10) Pub. No.: US 2006/0289559 A1
(43) Pub. Date: Dec. 28, 2006

(54) Beverage dispensing gas consumption detection with alarm and backup operation

(75) Inventor: Timothy S. Bodemann, Raleigh, NC (US)

Correspondence Address: COATS & BENNETT, PLLC, P O BOX 5, RALEIGH, NC, 27602, US

(73) Assignee: South-Tek Systems

(21) Appl. No.: 11/513,448

(22) Filed: Aug. 31, 2006

Related U.S. Application Data
(63) Continuation-in-part of application No. 11/156,859, filed on Jun. 20, 2005.

(51) Int. Cl. B67D 5/08; B67D 5/06; B65D 83/00

(52) U.S. Cl. 222/53; 222/61; 222/23; 222/399

(57) ABSTRACT

A CO₂-based beverage dispensing system includes a CO₂ monitoring unit operative to emit a warning upon detecting excessive consumption of CO₂ gas. The CO₂ monitoring unit includes a gas input port, a gas output port, a CO₂ monitor, an alarm, and in one embodiment a shut-off valve. The CO₂ monitor may measure CO₂ gas flow rate or pressure, and indicate excessive CO₂ gas consumption if the measured CO₂ gas flow rate is above a predetermined flow rate or the measured CO₂ gas pressure is below a predetermined pressure level. The CO₂ monitor may include chronological functionality, and only indicate excessive CO₂ gas consumption if the measured quantity trips a threshold for a predetermined duration.

This application is a continuation-in-part application of U.S. patent application Ser. No. 11/156,859, filed Jun. 20, 2005, the disclosure of which is incorporated herein by reference.

### BACKGROUND

The present invention relates generally to the field of beverage dispensing gas pressure systems and in particular to a system for detecting excessive CO₂ gas consumption, and emitting a warning of such.

Soft drinks dispensed from “soda fountains” are typically mixed in the dispenser. A carbonator generates carbonated water by mixing water and carbon dioxide (CO₂) under pressure. The carbonated water is mixed with syrup as it flows through the dispenser with the aid of CO₂ gas driven pump, into a cup. Bars, restaurants, convenience stores, and other businesses that sell soft drinks from a soda fountain maintain a tank of CO₂ gas, or in some cases a tank of liquid CO₂ (known as “Bulk Liquid” Storage), to provide CO₂ to the carbonator. In addition, many bars and restaurants use the pressurized CO₂ gas to drive beer and wine from kegs or other containers to be dispensed at taps. The CO₂ tank(s) and gas distribution system are typically leased from gas companies, who also refill the tanks as the CO₂ is depleted.

The gas companies set up regular “CO₂ fill” schedules for replenishing the CO₂ gas or liquid in the storage tanks. If the tank depletes prematurely—such as through a leak in a gas line or fitting, or if a tap to an empty beer keg is left open—the gas company must make an unscheduled service call to refill the tank(s). In some cases, these unscheduled service call represent up to ⅓ of the company's operating cost. If the cause of the service call is an open tap or other item that is clearly the fault of the lessee (i.e., the bar, restaurant, or store) the lessee is charged a penalty for the service call. If the cause of the leak is a malfunction or failure of the leased gas tank or distribution system, the cost of the service call must be absorbed by the gas company.

Automatic notification systems are known in the art that monitor CO₂ levels in the tanks, and use telemetry to notify the gas company when one or more CO₂ gas tanks are nearly empty. These systems are primarily used to create dynamic CO₂ fill schedules, so that service calls are only made when actually necessary. These systems function poorly to detect leaks or open taps, as they provide a warning only after one or more tanks are nearly empty. CO₂ gas detectors are known in the art that detect the presence of excessive CO₂ gas in a room. These detectors are primarily safety devices meant to avoid prolonged exposure to excessive CO₂ gas, which may result in oxygen deprivation. CO₂ gas detectors make poor leak or open tap detectors, as their effectiveness is highly dependent on detector placement, ambient air flow due to HVAC systems or open windows, and the like. In particular, CO₂ gas detectors may fail to detect relatively small leaks in an environment with adequate air circulation, even though over time the small leak may lose a significant amount of CO₂ gas from the system.

### SUMMARY

In one embodiment, the present invention relates to a beverage dispensing system. The system includes a carbon dioxide (CO₂) gas source and a beverage dispenser connected in gas flow relationship to the CO₂ gas source, the beverage dispenser using CO₂ gas to dispense one or more beverages. The system additionally includes a CO₂ monitoring unit interposed between the CO₂ gas source and the beverage dispenser, the CO₂ monitoring unit including a CO₂ monitor operative to monitor the consumption of CO₂ gas, and an alarm operatively connected to the CO₂ monitor and operative to emit a warning if the CO₂ monitor indicates excessive CO₂ consumption. The system may additionally include an in-line shut-off valve.

In another embodiment, the present invention relates to a CO₂ monitoring unit for a beverage dispensing system. The CO₂ monitoring unit includes a gas input port operative to be connected to a CO₂ gas source and a gas output port operative to be connected to a beverage dispenser using CO₂ gas to dispense one or more beverages. The unit additionally includes a CO₂ monitor interposed between the gas input port and the gas output port, the CO₂ monitor operative to monitor the consumption of CO₂ gas, and an alarm operatively connected to the CO₂ monitor and operative to emit a warning if the CO₂ monitor indicates excessive CO₂ consumption. The monitoring unit may additionally include an in-line shut-off valve.

### BRIEF DESCRIPTION OF DRAWINGS

FIG. 1 is a functional block diagram of a CO₂-based beverage dispensing system.

Figure two is a functional block diagram of a CO₂ monitoring unit.

### DETAILED DESCRIPTION

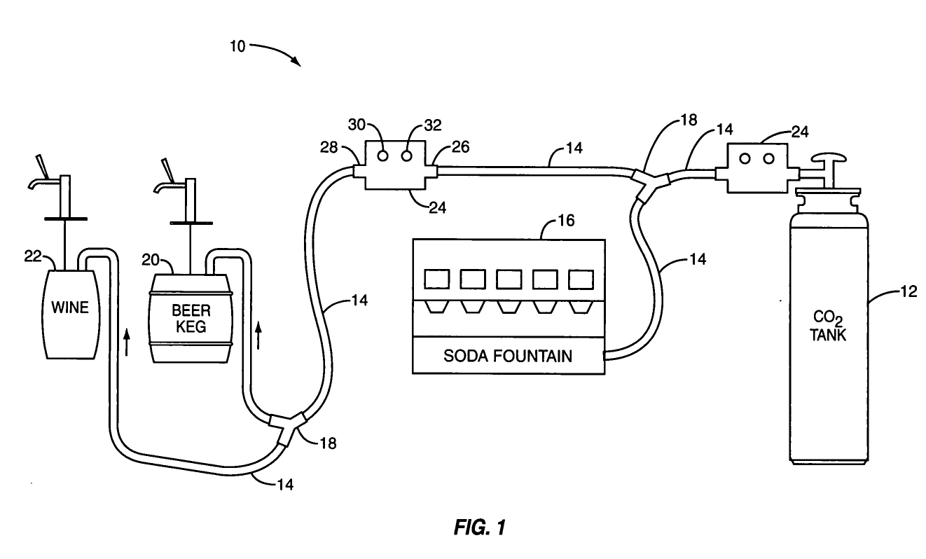

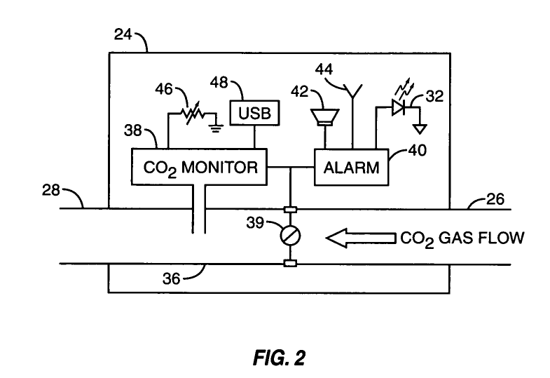

FIG. 1 depicts a CO₂-based beverage dispensing system according to one or more embodiments of the present invention, indicated generally at 10. The system 10 includes a CO₂ source, such as CO₂ gas tank 12, and one or more beverage dispensers that use CO₂ gas to dispense beverages. The beverage dispensers may include a soda fountain 16 with an internal carbonator (not shown) to generate carbonated water, or a beer keg 20 or wine barrel 22, which use CO₂ gas pressure to drive beverages to dispensing taps, and use the CO₂ gas to displace the beverage in the container. CO₂ gas is transported from the CO₂ gas tank 12 to the beverage dispensers 16, 20, 22 in gas distribution lines 14. CO₂ gas is utapped off” as necessary using “Y” splitters 18. Alternatively, a manifold may distribute CO₂ gas to a plurality of outputs, as required. Other elements commonly employed in beverage dispensing systems 10, such as shut-off valves, pressure gauges, and the like, are not necessary for an explanation of the present invention and are omitted from FIG. 1 for clarity.

Excessive consumption of CO₂ gas may result from improper fittings or punctures in one or more gas distribution lines 14 or couplers 18, or by malfunctioning CO2 gas driven pumps on the syrup injection system within the soda fountain system 16. Alternatively, or additionally, improper operation may cause excessive CO₂ gas consumption. For example, if a bartender leaves a tap connected to an empty keg 20 or barrel 22 in the open position, the CO₂ gas will flow freely, escaping into the air.

To detect excessive CO₂ gas consumption and issue a warning, one or more CO₂ monitoring units 24 are interposed between the CO₂ gas tank 12 and one or more beverage dispensers 16, 20, 22. A CO₂ monitoring unit 24 may be connected directly to the output of the CO₂ gas tank 12, or may be interposed along any gas distribution line 14. In one embodiment, the CO₂ monitoring unit 24 includes an in-line shut-off valve.

As depicted in FIG. 2, the CO₂ monitoring unit 24 includes a gas input port 26 and a gas output port 28, connected by a gas flow passage 36. Between the input port 26 and the output port 28, operatively connected to the gas flow passage 36, is a CO₂ monitor 38 that monitors properties of CO₂ gas flow to detect excessive CO₂ gas consumption. The CO₂ monitor 38 is operatively connected to an alarm 40 that emits a warning if the CO₂ monitor 38 detects excessive CO₂ gas consumption. The alarm signal output by the CO₂ monitor 38 may additionally actuate an in-line shut-off valve 39, cutting off the flow of CO₂ gas when excessive CO₂ gas consumption is detected.

In one embodiment, as depicted in FIG. 1, the CO₂ monitoring unit 24 includes output lights 30, 32 that provide a visual indication of the system 10 status, and a warning of excessive CO₂ gas consumption. The CO₂ monitor 38 may detect excessive CO₂ gas consumption in a variety of ways, and the alarm 40 may emit a warning of excessive CO₂ gas consumption in a variety of ways, as described herein.

In one embodiment, the CO₂ monitor 38 comprises a gas flow rate meter operative to measure the CO₂ gas flow rate from the gas input port 26 to the gas output port 28. The measured CO₂ gas flow rate is compared to a predetermined gas flow rate, and the alarm 40 emits a warning of excessive CO₂ gas consumption if the measured CO₂ gas flow rate exceeds the predetermined gas flow rate. In one embodiment, the predetermined gas flow rate is adjustable, and is preferably set to a value just above the flow rate of CO₂ gas in the system 10 when a few taps are dispensing beverages.

In another embodiment, the CO₂ monitor 38 additionally includes chronological functionality—that is, the ability to measure elapsed time. In this embodiment, the alarm 40 emits a warning of excessive CO₂ gas consumption only if the measured CO₂ gas flow rate exceeds a predetermined gas flow rate for a predetermined duration, e.g., 15 minutes. In this embodiment, a brief duration of unusually high CO₂ gas flow rate will not trigger a warning of excessive CO₂ gas consumption. This condition may occur, for example, if an empty keg 20 is changed without shutting off the gas distribution line 14 at the appropriate shut-off valve, or if a gas distribution line 14 comes loose from a coupling 18, and is discovered and quickly re-attached. However, a sustained high gas flow rate that exceeds the predetermined duration indicates a leak, open tap, or the like, for which a warning should be emitted to alert personnel of the problem, prompting a search for the leak or other corrective action to avoid further loss of CO₂ gas.

In one embodiment, the CO₂ monitor 38 comprises a gas flow detector operative detect gas flow, but not necessarily measure the gas flow rate. That is, the gas flow detector is operative to distinguish between any CO₂ gas flow from the gas input port 26 to the gas output port 28 and no CO₂ gas flow from the gas input port 26 to the gas output port 28. In this embodiment, the CO₂ monitor 38 also includes chronological functionality. The CO₂ monitor 38 indicates excessive CO₂ consumption upon detecting sustained CO₂ gas flow (at any flow rate) from the gas input port to the gas output port for a predetermined duration, e.g., two hours. In any beverage dispensing system 10, there will be at least brief periods between beverage dispensing operations when all taps and soda fountain dispensers 16 will be off, and no CO₂ gas should flow to beverage dispensers 16, 20, 22. In this embodiment, a warning of excessive CO₂ consumption is emitted if there is no “no flow” condition during the predetermined duration—that is, if CO₂ gas flows continuously through the CO₂ monitoring unit 24 for, e.g., two hours without interruption.

In one such embodiment, the state of the beverage dispensing system 10 is indicated by first and second output lights 30, 32. For example, the first output light 30 may comprise a green LED, and the second output light 32 a red LED (see FIG. 2). The green LED 30 is illuminated when the CO₂ monitor 38 detects gas flow through the CO₂ monitoring unit 24. The red LED 32 is illuminated when the CO₂ monitor 38 does not detect any gas flow through the CO₂ monitoring unit 24. If no “no flow” condition occurs over the predetermined duration, the alarm 40 emits a warning of excessive CO₂ consumption. In this case, the red LED 32 may flash, possibly in addition to another form of warning, such as sounding an audible alarm via speaker or buzzer 42.

In another embodiment, the CO₂ monitor 38 comprises a pressure monitor operative to detect the pressure of CO₂ gas in the gas flow passage 36. The detected CO₂ gas pressure is compared to a predetermined pressure level, and the alarm 40 emits a warning of excessive CO₂ gas consumption if the detected CO₂ gas pressure falls below the predetermined pressure level. The CO₂ gas pressure level in the beverage dispensing system 10 will drop slightly every time a tap is opened or the carbonator in the soda fountain 16 takes in more CO₂ gas. However, a leak or an open tap connected to an empty keg 20 or barrel 22 will cause a significant drop in pressure. Accordingly, the predetermined pressure level, which in one embodiment is adjustable, is preferably set to a value just below the normal system 10 operating pressure when a few taps are dispensing beverages.

In another embodiment, the CO₂ monitor 38 detecting gas pressure additionally includes chronological functionality. In this embodiment, the alarm 40 emits a warning of excessive CO₂ gas consumption only if the detected CO₂ gas pressure remains below the predetermined pressure level for a predetermined duration. In this embodiment, a brief but significant drop in CO₂ gas pressure will not trigger a warning of excessive CO₂ gas consumption. Such a pressure drop may occur, for example, when dispensing the last beverage from a keg 20 or barrel 22, and CO₂ gas flows freely through the tap following the last of the beverage, before an operator has time to close the tap.

In any of the embodiments described herein, if the CO₂ monitor 38 indicates excessive CO₂ gas consumption, the alarm 40 will issue a warning. In some embodiments, the alarm 40 is integrated with the CO₂ monitor 38 within the CO₂ monitoring unit 24, as depicted in FIG. 2. In other embodiments, the alarm 40 may be a separate unit, communicating with the CO₂ monitor 38 in the CO₂ monitoring unit 24 by a wired or wireless data link (not shown). In either case, the excessive CO₂ gas consumption warning may be audible, such as by driving a speaker or buzzer 42. Alternatively, or additionally, the warning may comprise a visual indicator, such as illuminating a steady or flashing light (incandescent or LED 32), displaying a warning message on a display panel (not shown), or the like. In one embodiment, the alarm may output a wired or wireless electronic signal to a data processing system such as a PC, a point of sale (POS) terminal system, or the like. In one embodiment, the alarm may initiate a wireless page or cellular call to a CO₂ leasing company, a CO₂ gas supplier, a service facility, the establishment's manager's cell phone, or the like, via antenna 44.

Upon noticing the warning issued by the alarm, a user or service technician may inspect the beverage dispensing system 10 for leaks or operator errors, and/or may initiate diagnostics testing. The manager of the establishment operating the beverage dispensing system 10 will be prompted to perform at least a cursory inspection of the system 10 upon noticing the excessive CO₂ gas consumption warning, since the establishment will be charged for a service call in the cause of the excessive CO₂ gas consumption is the fault of the establishment, such as an open tap.

In some embodiments, the predetermined threshold(s) of the CO₂ monitor 38 may be easily altered, for example, to the original predetermined gas flow rate threshold plus 10%, or the original predetermined gas pressure level minus 10%. This may allow an operator to account for transient, unusually heavy use of the beverage dispensing system 10 (such as during a sporting event or other occasion prompting a surge of beer sales).

In any of the embodiments described herein, predetermined threshold(s) of the CO₂ monitor 38 may be altered in a variety of ways. In one embodiment, a dial or set screw 46 may be provided on the CO₂ monitoring unit 24. An operator may calibrate the CO₂ monitoring unit 24 by turning the dial or set screw 46 to maximum sensitivity, dispensing beverages through a plurality of taps to cause the alarm 40 to emit a warning of excessive CO₂ gas consumption, and turning the dial or set screw 46 to lower sensitivity until the warning ceases. In another embodiment, the CO₂ monitoring unit 24 includes a computer interface, such as a USB port 48. Software provided with the CO₂ monitoring unit 24 guides a user through a calibration process, and sets the predetermined threshold(s). In this embodiment, the software may additionally perform extensive diagnostics on the CO₂ monitoring unit 24. In another embodiment, the predetermined threshold(s) of the CO₂ monitor are fixed.

By monitoring the consumption of CO₂ gas in a beverage dispensing system 10, the CO₂ monitoring unit 24 may alert users to excessive consumption of CO₂ gas. In one embodiment, the CO₂ monitoring unit 24 may additionally actuate an in-line shut-off valve to halt the flow of CO₂ gas. The shut-off valve may be reset when the leak is located and repaired. This may significantly reduce operating costs, both by postponing the need to purchase a new tank full of CO₂ gas, and by avoiding service fees associated with an unscheduled CO₂ fill by a gas provider.

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention. In particular, while different embodiments of the various aspects of functionality have been individually described—e.g., excessive CO₂ gas consumption detection techniques, forms of warning, means for adjusting predetermined threshold(s), and the like—the present invention encompasses any and all permutations of these embodiments within any particular CO₂ monitoring unit 24. The present embodiments are therefore to be construed in all aspects as illustrative and not restrictive and all changes coming within the meaning and equivalency range of the appended claims are intended to be embraced therein.

What is claimed is:

1. A beverage dispensing system, comprising:
a carbon dioxide (CO₂) gas source;
a beverage dispenser connected in gas flow relationship to the CO₂ gas source, the beverage dispenser using CO₂ gas to dispense one or more beverages;
a CO₂ monitoring unit interposed between the CO₂ gas source and the beverage dispenser, the CO₂ monitoring unit including a CO₂ monitor operative to monitor the consumption of CO₂ gas; and
an alarm operatively connected to the CO₂ monitor and operative to emit a warning if the CO₂ monitor indicates excessive CO₂ consumption.

2. The system of claim 1 wherein the CO₂ monitor is a gas flow rate meter operative to measure the CO₂ gas flow rate from the CO₂ gas source, the CO₂ monitor indicating excessive CO₂ consumption when the measured CO₂ gas flow rate exceeds a predetermined flow rate.

3. The system of claim 2 wherein the CO₂ monitor further includes chronological functionality, and wherein the CO₂ monitor indicates excessive CO₂ consumption upon measuring a sustained CO₂ gas flow rate in excess of a predetermined flow rate for a predetermined duration.

4. The system of claim 1 wherein the CO₂ monitor is a gas flow detector operative to distinguish between any CQ₂ gas flow from the CO₂ gas source and no CO₂ gas flow from the CO₂ gas source, and further including chronological functionality, wherein the CO₂ monitor indicates excessive CO₂ consumption upon detecting sustained CO₂ gas flow from the CO₂ gas source for a predetermined duration.

5. The system of claim 1 wherein the CO₂ monitor is a pressure monitor operative to detect CO₂ gas pressure, the CO₂ monitor indicating excessive CO₂ consumption when the detected CO₂ gas pressure falls below a predetermined level.

6. The system of claim 5 wherein the CO₂ monitor further includes chronological functionality, and wherein the CO₂ monitor indicates excessive CO₂ consumption upon detecting CO₂ gas pressure continuously below a predetermined level for a predetermined duration.

7. The system of claim 1 further comprising a shut-off valve operatively connected to the CO₂ monitor and operative to halt the flow of CO₂ gas in the system if the CO₂ monitor indicates excessive CO₂ consumption.

8. The system of claim 1 wherein the alarm warning is audible.

9. The system of claim 1 wherein the alarm warning is visible.

10. The system of claim 1 wherein the alarm warning is an electronic signal communicated to a data processing system.

11. The system of claim 1 where the alarm warning activates a wireless communication to a service facility.

12. A CO₂ monitoring unit for a beverage dispensing system, comprising:
a gas input port operative to be connected to a CO₂ gas source;
a gas output port operative to be connected to a beverage dispenser using CO₂ gas to dispense one or more beverages;
a CO₂ monitor interposed between the gas input port and the gas output port, the CO₂ monitor operative to monitor the consumption of CO₂ gas; and
an alarm operatively connected to the CO₂ monitor and operative to emit a warning if the CO₂ monitor indicates excessive CO₂ consumption.

13. The CO₂ monitoring unit of claim 12 wherein the CO₂ monitor is a gas flow rate meter operative to measure the CO₂ gas flow rate from the gas input port to the gas output port, the CO₂ monitor indicating excessive CO₂ consumption when the measured CO₂ gas flow rate exceeds a predetermined flow rate.

14. The CO₂ monitoring unit of claim 13 wherein the CO₂ monitor further includes chronological functionality, and wherein the CO₂ monitor indicates excessive CO₂ consumption upon measuring a sustained CO₂ gas flow rate in excess of a predetermined flow rate for a predetermined duration.

15. The CO₂ monitoring unit of claim 12 wherein the CO₂ monitor is a gas flow detector operative to distinguish between any CO₂ gas flow from the gas input port to the gas output port and no CO₂ gas flow from the gas input port to the gas output port, and further including chronological functionality, wherein the CO₂ monitor indicates excessive CO₂ consumption upon detecting sustained CO₂ gas flow from the gas input port to the gas output port for a predetermined duration.

16. The CO₂ monitoring unit of claim 15 wherein the alarm comprises first and second output lights, the first light illuminated in response to the CO₂ monitor detecting gas flow from the gas input port to the gas output port, and the second light illuminated in response to the CO₂ monitor detecting no gas flow from the gas input port to the gas output port.

17. The CO₂ monitoring unit of claim 16 wherein the alarm warning comprises flashing the second output light in response to detecting no gas flow from the gas input port to the gas output port for a predetermined duration.

18. The CO₂ monitoring unit of claim 12 wherein the CO₂ monitor is a pressure monitor operative to detect CO₂ gas pressure, the CO₂ monitor indicating excessive CO₂ consumption when the detected CO₂ gas pressure falls below a predetermined level.

19. The CO₂ monitoring unit of claim 18 wherein the CO₂ monitor further includes chronological functionality, and wherein the CO₂ monitor indicates excessive CO₂ consumption upon detecting CO₂ gas pressure continuously below a predetermined level for a predetermined duration.

20. The CO₂ monitoring unit of claim 12 further comprising a shut-off valve operatively connected to the CO₂ monitor and operative to halt the flow of CO₂ gas through the monitoring unit if the CO₂ monitor indicates excessive CO₂ consumption.

21. The CO₂ monitoring unit of claim 12 wherein the alarm warning is audible.

22. The CO₂ monitoring unit of claim 12 wherein the alarm warning is an electronic signal communicated to a data processing system.

23. The CO₂ monitoring unit of claim 12 where the alarm warning activates a wireless communication to a service facility.
